(19) United States
(12) Patent Application Publication
(10) Pub. No.: US 2010/0326679 A1
(43) Pub. Date: Dec. 30, 2010

(54) Device for Landscape Care or the Like Machine

(76) Inventor: Dirk Tielbürger, Rahden (DE)

Correspondence Address: GUDRUN E. HUCKETT DRAUDT, SCHUBERTSTR. 15A, WUPPERTAL, 42289, DE

(21) Appl. No.: 12/817,285

(22) Filed: Jun. 17, 2010

(30) Foreign Application Priority Data
Jun. 18, 2009 (DE) 10 2009 029 809.6

(51) Int. Cl. A01D 80/02

(52) U.S. Cl. 172/29

(57) ABSTRACT

A landscape care device has at least one treatment device provided with spring tines secured on a support beam, wherein the spring tines are each connected immediately positive-lockingly to the support beam. The treatment device is a dethatching device and the spring tines are arranged in a single row or multi-row arrangement on the support beam. The spring tines have at least one support contour that passes through a receiving opening of the support beam and defines a contact area in such a way that the spring tines are secured substantially in a self-looking way on the support beam by the support contour.

The invention concerns a landscape care device, in particular in the form of a lawn tractor, a sweeping machine or like machine driven by a motor, according to the preamble of claim 1.

Landscape care devices, in particular with care tools provided for lawn treatment, have been known for a long time. In addition to the mowing device, they can be provided with a dethatcher wherein the latter comprises a support beam in the form of a roller, a bar, or similar constructions provided with spring tines.

In very different embodiments, these spring tines are secured by additional screw connections on the support beam so that particularly for a wear-caused exchange of the spring tines a screw connection that after extended operating time is corroded must be released and, accordingly, a correspondingly high expenditure results in connection with servicing. Such screw-connected spring tines are also known to be used in agricultural soil treatment machines such as sowing machines, hay turning machines, mowing blades, combing machines for golf courses or the like (DE 100 43 851 A1).

The invention is directed to the problem to provide a landscape care device wherein in connection with its dethatching device that is provided as an attachment assembly a simple mounting of spring tines is enabled and, in this context, the support beam can be used repeatedly for an extended period of time after a fast exchange even of individual spring tines that are available at minimal manufacturing costs.

The invention solves this object with a landscape care device with the features of claim 1. Further advantageous embodiments result from the claims 2 to 20.

The landscape care device in the form of a lawn tractor, a sweeping machine or the like device comprises as a treatment tool at least one dethatcher wherein the latter is provided according to the invention with spring tines that are useable as an active unit for soil treatment and are to be secured to the support beam only by means of an immediate positive-locking connection.

In this way, a significantly simplified assembly is provided in which the spring tines are only clamped in a positive-locking connecting position on the support beam like “lockable bristles” and in this way a surprisingly stable functional unit is achieved.

With appropriate optimization of this inserting/clamping fixation a bending-stable and anti-rotation functional position of the spring tines is provided that act optimally in particular during dethatching. In case of an age-caused or wear-caused exchange even of individual ones of the spring tines a fast demounting is possible with minimal technical expenditure and with a comparatively simple insertion process new spring tines can be inserted immediately into the support beam or pressed into it and can be secured in position by elastic restoring movement of a partial section of the spring tines.

The inventively formed spring tines are provided at one end with a shaped area usable as a support contour so that this section of the spring tines can be inserted into a receiving opening of the support beam and can be contacted on a contact area of the support beam that acts as a counter bearing such that a “pretensioned” support position is achieved. For all of the substantially variably designed spring tine embodiments an additional fixation in the form of screws, cotter pins, or the like securing elements are not needed so that for landscape care devices a construction is achieved that is suitable in particular for private use and repair.

The concept of the positive-lockingly secured spring tines provides that also rotatingly driven tools can be equipped with them. On the support beam that in this case is embodied as a support shaft the spring tine can be arranged in a coil shape and in multiple rows.

When using the positive-lockingly secured spring tines on a tool that is provided as a sweeping brush, it is only required to secure the spring tines in radial direction in a pull-resistant way so that additional measures for an anti-rotational receiving and supporting action of the spring tines is not needed.

The field of application of this spring tine fixation construction according to the invention is not limited to the advantageous use in landscape care devices in private gardens or the like. Instead, this new assembly can also be used in agricultural devices for soil treatment, hay turning machines or like attachments.

Further details and advantageous embodiments of the invention result from the following description and the drawing in which several embodiments of the landscape care device with the spring tines according to the invention are disclosed in more detail. The drawing shows in:

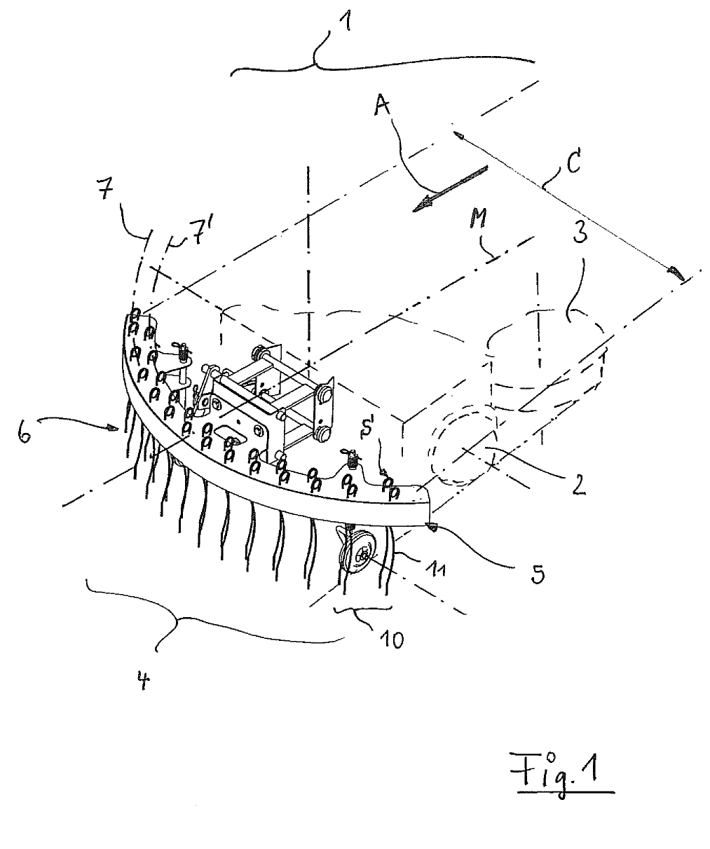

FIG. 1 a perspective illustration of a schematically illustrated machine for landscape care with dethatcher at the front end;

FIG. 2 in enlarged detail illustration the spring tine in the area of a support beam on the dethatcher;

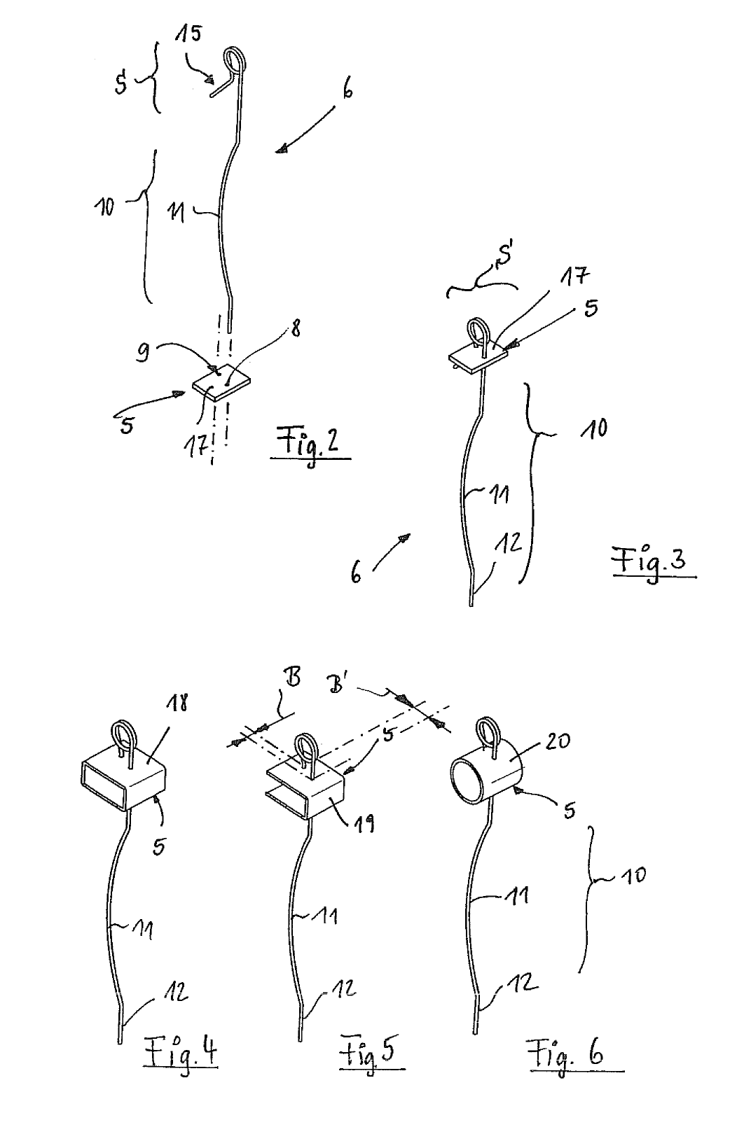

FIG. 3 a view similar to FIG. 2 with the individual spring tines in the mounted position on the support beam;

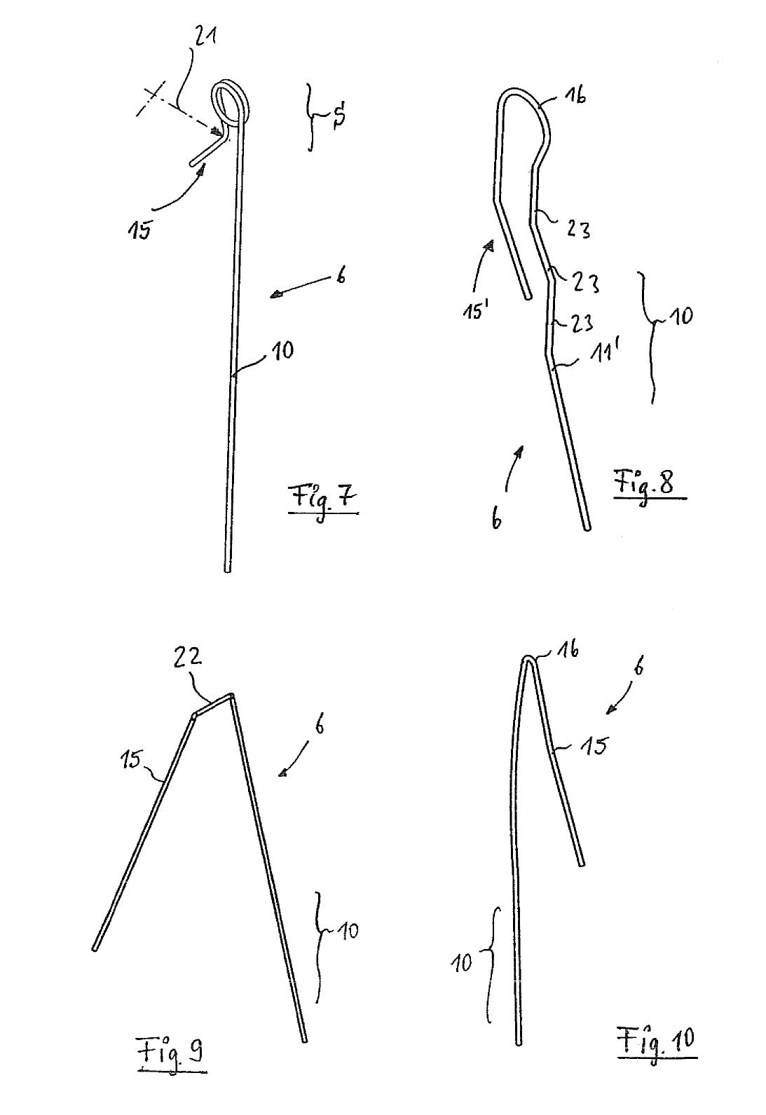

FIG. 4 to FIG. 6 perspective illustrations, respectively, similar to FIG. 3, with the spring tines on differently embodied support beams;

FIG. 7 to FIG. 12 individual illustrations, respectively, of different embodiments of the spring tines according to the invention;

FIG. 13 to FIG. 15 cross-sectional illustrations, respectively, of the holder of the dethatcher with spring tines in different clamping positions;

FIG. 16 an embodiment of the spring tine formed with two bristle parts;

FIG. 17 an embodiment of the spring tine similar to FIG. 16 in the connecting area on the support beam;

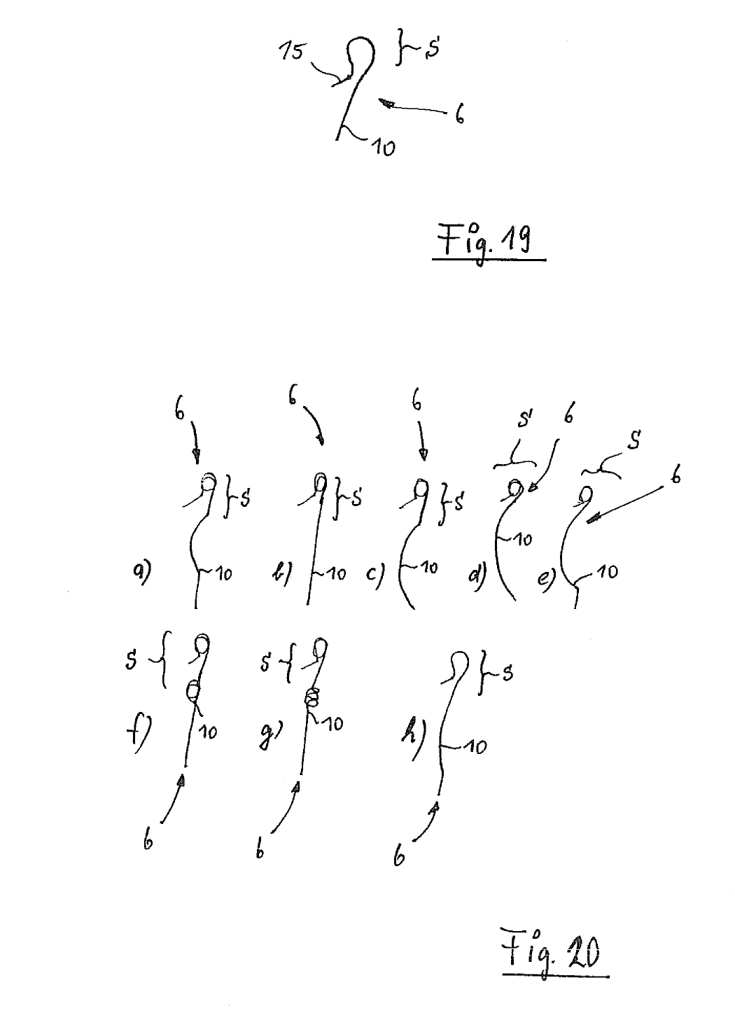

FIG. 18 a tab that is provided for securing the spring tine according to FIG. 17;

FIG. 19 a principal illustration of the spring tine similar to FIG. 2 with a simplified securing contour; and

FIG. 20 embodiment variants, respectively, according to a) to h) with differently shaped spring tines similar to FIG. 19.

In FIG. 1 a landscape care device referenced as a whole by 1 is illustrated wherein schematically it is indicated that it is in the form of a sweeping machine, a lawn tractor or a similar assembly. For use of such landscape care devices 1 it has been found to be advantageous that several care or ground treatment tools can be integrated into the concept of this machine. In FIG. 1 it becomes apparent that, in addition to a mowing device 3 that is arranged in the working direction A behind appropriate support wheels 2, further attachments can be connected to the device. Illustrated is a dethatching device referenced as a whole by 4. It is embodied as a construction with spring tines 6 on a support beam 5 as an active assembly.

This embodiment of the dethatching device 4 conceptualized as an attachment assembly is characterized according to the invention in that on the support beam 5 spring tines 6 are provided that are connectable to it immediately in a positive-locking way. When cutting a lawn or performing a similar treatment action a dethatching action can be performed in front thereof because this system is constructed as a surprisingly effectively usable assembly.

This dethathing device 4—as one embodiment of the treatment device 4 according to the invention—can thus be provided with “fixed” spring tines 6 or they can be secured to a drive shaft (not illustrated) in such a way that—in contrast to the “pushed” unit—a rotating dethatcher is formed.

In an embodiment known per se, the respective working width C of this dethatching device 4 is predetermined in that on the support beam 5 several spring tines 6 aligned in a row arrangement 7 are provided. In the illustrated dethatching device 4 the support beam 5 is designed such that two rows 7, 7′ of the spring tines 6 can be received.

When looking at FIG. 2 and FIG. 3, it is apparent that for realization of the immediate positive-locking beam/tine connection the spring tines 6 are shaped to have at least one support contour S that passes through a receiving opening 8 of the support beam 5 and defines thereat a contact area 9. In this way, it is achieved that the spring tines 6 by means of this support contour S are substantially secured in a self-locking action on the support beam 5. In the illustrations according to FIGS. 4 to 20, different embodiments of these spring tines 6 that are provided for immediate positive-locking support will be explained in more detail in the following.

In the illustrations, the illustrated spring tines 6 are formed as contour rods that in cross-section are circular wherein also other cross-sections (not illustrated) of the spring tines 6 that are conceived as monolithic shaped parts of spring steel are conceivable.

From the mounted positions of the spring tines 6 secured on the support beam 5 according to FIGS. 3 to 6 it is apparent that the spring tines 6 that are secured with one end on the support beam 5 provide with the other end a freely projecting bristle part 10 defining the active area provided for ground treatment. This bristle part 10 can be provided with a curved shape contour 11 in the longitudinal direction that passes into a pointed front area 12. This area 12 defines an active zone that engages the grass or the soil and the curved shape contour 11 provides optimal working conditions in the mounted position (FIG. 1). It is provided in this connection that the spring tines 6 in the working direction A (FIG. 1) are concavely oriented. In this way, in particular in front of the trailing mowing device 3 an optimal engagement and “erection” of the grass and soil parts is achieved so that after this two-phase treatment an optimal cleaning and loosening of the soil structure or cutting of the lawn is ensured.

When looking at FIGS. 3 to 6 and FIGS. 14 and 15, it is apparent that the support beam 5 is preferably provided with two receiving openings 8, 9 and 13, 14. In this connection, a first one of the receiving openings—8 or 13—is engaged by the spring tine 6 with the upper end of its bristle part 10 and the second receiving opening or contact area—i.e., 9 and 14—is engaged by the spring tine 6 with its support projection 15 of the support contour S. This basic configuration of the spring tines 6 for immediate positive-locking connection is repeated with appropriate variations in all of the illustrated embodiments according to FIGS. 7 to 20.

From the section illustrations according to FIGS. 14 and 15 it is apparent that at least one of the receiving openings, i.e., the openings 14, may be embodied as a slotted hole L so that in deviation from the receiving opening 13 an entire arc-shaped area 16 of the support projection 15 of the spring tines 6 is engaged and therefore their fixation is stabilized. The mounting direction of this assembly is indicated with arrow D. In the illustrated mounting position, a positive-locking connection is achievable that secures the spring tine 6 also against rotation.

In FIG. 5, the afore described paired interaction of receiving openings 8 and 9 is apparent wherein the openings are laterally displaced at a spacing identified at B, B′ relative to one another in the support beam 5. Already in this way, with a minimal technical expenditure an anti-rotation action for the spring tines 6 can be achieved.

In the simplest embodiment (FIG. 3) it is provided that the support beam 5 is comprised of a single layer plate bar 17 and in it the two receiving openings 8, 9 (contact area) are introduced (FIG. 2). The illustrations according to FIGS. 4 to 6 and FIGS. 13 to 15 illustrate a further embodiment of the support beam 5 wherein the latter is embodied as a closed hollow profiled section 18, 19, 20 or one that is at least open at one side. It is understood that in this connection at least the receiving opening 8 may penetrate several wall sections of the hollow profiled section (FIG. 14). In particular, it is provided that the hollow profiled parts have a U-shaped 19, rectangular 18, or circular 20 cross-sectional contour (FIGS. 4 to 6 or FIGS. 13 to 15).

Based on FIG. 7, in combination with FIGS. 19 and 20, it is apparent that the spring tines 6 in the area of their support contour S may be embodied as a single coil or multi-coil twin spiral. Based on this twin spiral the respective support projection 15 is designed such that in the area of its free end a contact radius 21 is formed with which in the mounted position (FIGS. 3 to 6) an optimal support is provided.

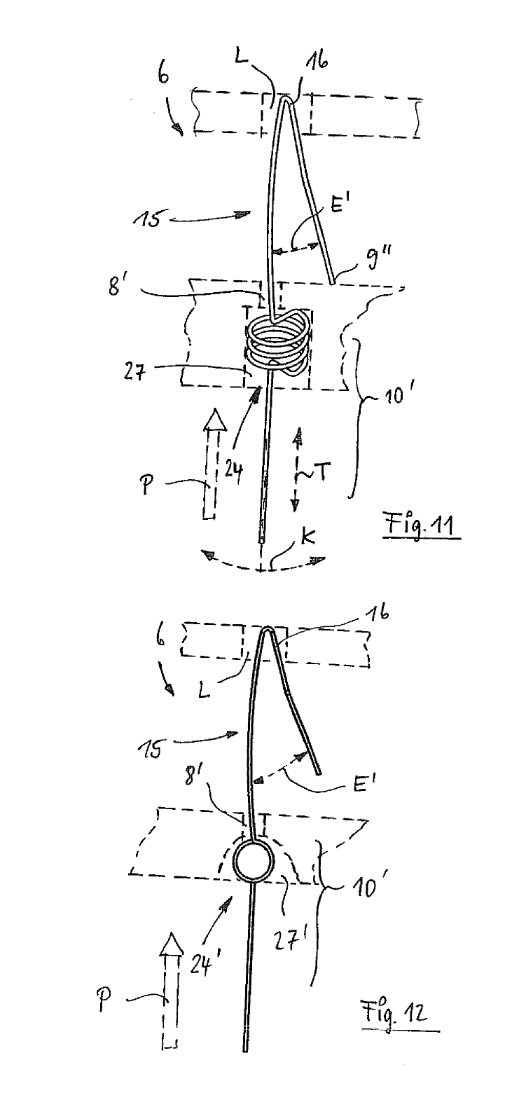

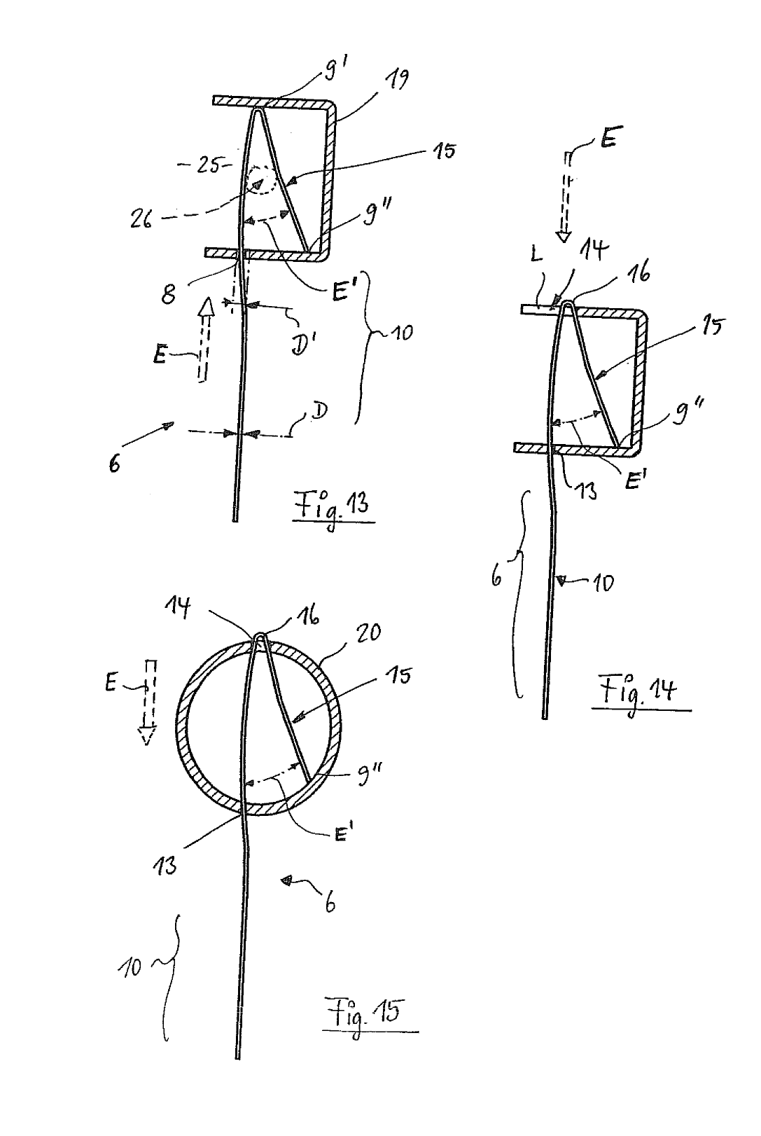

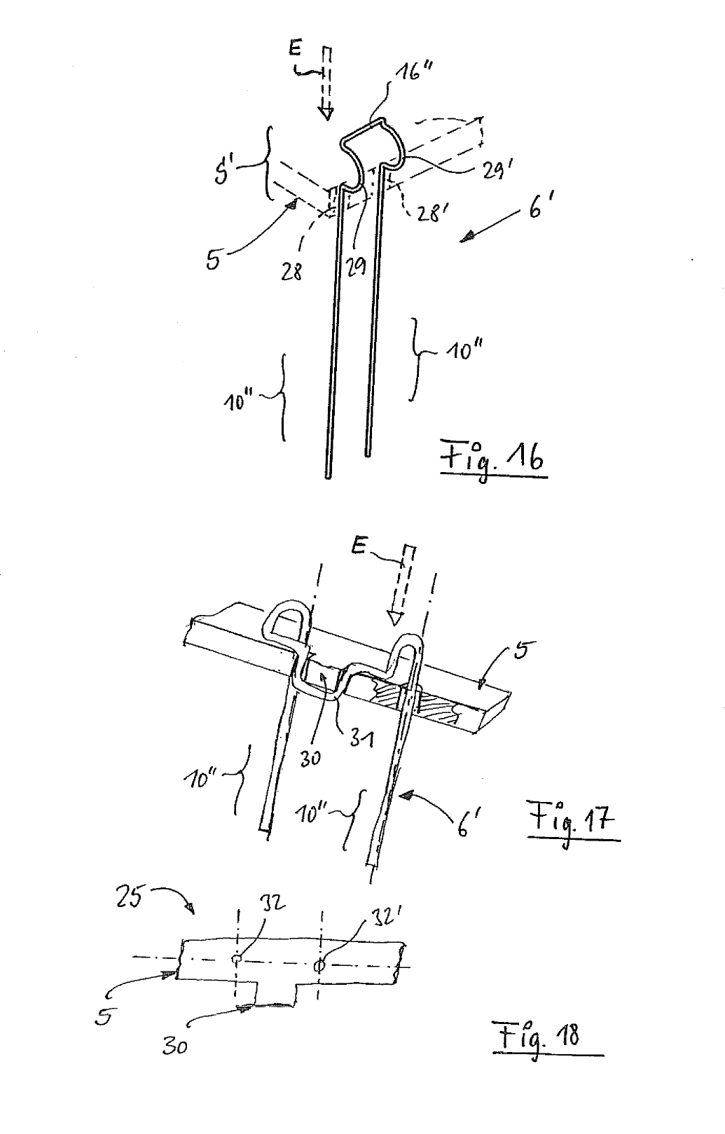

In FIGS. 8 to 11 further embodiments of spring tines 6 are illustrated wherein in the area of their support contour S they may have a transversely extending area 22 (FIG. 9) that is matched to the displacement B, B′ of the receiving openings 8, 9 or 13, 14 in the support beam 5. In the embodiment according to FIG. 8 the support projection 15′ is bent back toward the shaped area 11′ of the spring tine 6 and in the area 11′ of the bristle part 10 several shaped areas 23 are provided.

The embodiments according to FIGS. 10 to 12 show further simplified spring tines 6, wherein in FIGS. 13 to 15 the respective mounted position of the embodiment of these spring tines 6 in accordance with FIG. 10 becomes apparent.

In FIG. 13 the receiving opening 8 has a diameter D′ that is substantially twice as large as the diameter D of the spring tine 6. During mounting E, the front support projection 15 is displaced in the direction of arrow E′ toward the bristle part 10 so that insertion into the opening 8 can be realized. Subsequently, the support projection 15 moves into the illustrated position and is secured at 9′ and 9″ in the contact area. Conceivable is also to secure the already secured spring tines 6 against rotation by an additional positive locking action by means of a transverse shaft 26, or a similar insertion part, extending in the interior 25 of the hollow profiled section 19.

In the embodiment according to FIG. 14 the spring tine 6 can be mounted in direction E such that the bristle part 10 is guided through the opening 13 and subsequently the arc-shaped support area 16 is secured on the flanks of the slotted hole L against rotation. In FIG. 15, additional contact is also defined at 16 so that the spring tine 6 is secured against rotation in the hollow profile 20.

Appropriate mounting positions are provided when according to FIGS. 11 and 12 the spring tines 6 that are provided in the area of their bristle part 10′ with special contours 24 are pressed into the support beam 5 (arrow P). In this connection, the support projection 15 extends through a bore 8′ and is secured against rotation in the slotted hole L by the curved shape 16 and the area 9′. At the same time, the coiled special contour 24, 24′ engages an opening in the support beam 5 which opening is provided in the form of a blind bore 27, 27′ or a similar shaped recess so that in addition to the possible (“swaying”) movement K (FIG. 11) a compression movement T of the spring tine 6 can be compensated and thus the bristle part 10′ is effective when treating soil, grass surfaces or the like. In FIG. 12 a configuration similar to the afore described embodiment of the spring tine 6 is illustrated.

In FIG. 16 a further embodiment of a spring tine 6′ is illustrated wherein it is formed beginning with a monolithic rod part with two bristle parts 10′ and the two have a common support contour S′. This spring tine 6′ is insertable in the direction E in respective openings 28, 28′ and the upper shaped part 16″ can be secured on the support beam 5 by a clamping connection in such a way that the elastic shaped bends 29, 29′ are positioned in appropriate support position.

In FIG. 17 a construction that is similar to the spring tine 6′ according to FIG. 16 is illustrated in mounted position E wherein an additional support projection 30 on the support beam 5 (FIG. 18) is provided for fixation of the assembly. The spring tine 6′ has a shaped projection 31 that is similar to the support bends 29, 29′ (FIG. 16) that, in the positive-locking connecting position shown in FIG. 17, engages the support projection 30 wherein the two bristle parts 10′ extend at the same time through the respective through openings 32, 32′ and therefore an elastically clamped position with appropriate positive-locking contact is achieved.

In FIG. 19, based on the preferred embodiment according to FIG. 2, a simple curved embodiment of the spring tine 6 is illustrated and in FIG. 20 respective embodiments according to a) to h) show conceivable configurations of the spring tines 6 that are provided with variable bent contours in the area of the support contour S or the respective bristle parts 10.

what is claimed is:

1-20. (canceled)

21. A landscape care device comprising at least one treatment device provided with spring tines secured on a support beam, wherein the spring tines are each connected immediately positive-lockingly to the support beam.

22. The landscape care device according to claim 21, wherein the treatment device is embodied as a dethatching device, wherein the spring tines are arranged in a row on the support beam.

23. The landscape care device according to claim 21, wherein the spring tines are arranged in several rows on the support beam.

24. The landscape care device according to claim 21, wherein the spring tines are rotatably drivable.

25. The landscape care device according to claim 21, wherein the spring tines for soil treatment are movable by a push movement.

26. The landscape care device according to claim 21, wherein the spring tines comprise at least one support contour that passes through a receiving opening of the support beam and defines a contact area in such a way that the spring tines are secured substantially in a self-looking way on the support beam by the support contour.

27. The landscape care device according to claim 21, wherein the spring tines are embodied as contour rods that have a circular cross-section.

28. The landscape care device according to claim 21, wherein the spring tines have a first end positive-lockingly secured on the support beam in a mounted position on the support beam and have a second end defining a freely projecting bristle part.

29. The landscape care device according to claim 28, wherein the bristle part in longitudinal direction has a curved shape contour.

30. The landscape care device according to claim 21. wherein the support beam is provided with two through bores for each one of the spring tines, wherein a first one of the two through bores provides a receiving opening and a second one of the two through bores provides a contact area for the spring tines.

31. The landscape care device according to claim 30, wherein the spring tines each have a bristle part penetrating the receiving opening and further have a support contour with a support projection secured on the contact area.

32. The landscape care device according to claim 30, wherein at least one of the two through bores is shaped as a slotted hole.

33. The landscape care device according to claim 31, wherein the two through bores are arranged at a spacing to one another and in longitudinal or transverse direction of the support beam are displaced relative to one another.

34. The landscape care device according to claim 31, wherein the support beam is comprised of a single layer plate bar and the two through bores are provided therein.

35. The landscape care device according to claim 31, wherein the support beam is embodied as a hollow profiled section that is closed or open at least at one side, wherein one of the two through bores passes coaxially through several wall areas of the hollow profiled section.

36. The landscape care device according to claim 35, wherein the hollow profiled section has a U-shaped cross-sectional contour, a rectangular cross-sectional contour or a circular cross-sectional contour.

37. The landscape care device according to claim 31, wherein the support contour is formed as an at least single-coil twin spiral so that at least the support projection of the support contour has a free end with a contact radius that engages the receiving opening of the support beam.

38. The landscape care device according to claim 33, wherein the support contour defines a cross-sectional area matched to a displacement of the two through bores in the support beam.

39. The landscape care device according to claim 21, wherein the spring tines each are formed from a monolithic rod part with two bristle parts and a common support contour connecting the two bristle parts.

40. A dethatcher comprising a support beam and spring tines, wherein the spring tines are each connected immediately positive-lockingly to the support beam.
